(19) United States
(12) Patent Application Publication
(10) Pub. No.: US 2014/0280976 A1
(43) Pub. Date: Sep. 18, 2014

(54) MOBILE COMPUTING CLOUD AND VIRTUAL MOBILE INFRASTRUCTURE TO OPTIMIZE GROUP RESOURCES

(71) Applicant: REINVENTING GEOSPATIAL, INC., Fairfax, VA (US)

(72) Inventors: Michael Joseph GILLOTTE, JR., Clifton, VA (US); Shane Emmet Brennan, Alexandria, VA (US); Stephen Andrew Gillotte, Ashburn, VA (US); Joseph Scott Harvey, Clifton, VA (US)

(73) Assignee: REINVENTING GEOSPATIAL, INC., Fairfax, VA (US)

(21) Appl. No.: 14/210,721

(22) Filed: Mar. 14, 2014

Related U.S. Application Data
(60) Provisional application No. 61/798,549, filed on Mar. 15, 2013.

(51) Int. Cl. H04L 12/911

(52) U.S. Cl. CPC H04L 47/70
USPC 709/226

(57) ABSTRACT

The present invention relates to a system and method for optimizing the resources of a network of mobile devices. In one embodiment, a system encompasses multiple software components that work to communicate available resources among devices. In some embodiments, a method scores devices according to a collection of resource properties and scores services offered by each device to determine the best device for relevant tasks. The resource properties and services are weighted against a set of parameters that define the computing action taking place for a given service or resource request. The best available device for a relevant task is then updated in a name resolution service, such as a DNS server or host file.

### CROSS-REFERENCE TO RELATED APPLICATIONS

The present invention claims priority to U.S. Provisional Application No. 61/798,549, filed Mar. 15, 2013, and entitled “MOBILE COMPUTING CLOUD AND VIRTUAL MOBILE INFRASTRUCTURE TO OPTIMIZE GROUP RESOURCES,” which is herein incorporated by reference in its entirety.

### FIELD

The present invention relates to mobile devices, and more particularly, it relates to maximize the performance, such as computing power and battery life, of a group of mobile devices that are connected together over a network.

### BACKGROUND

Mobile computing devices have become increasingly popular in recent years. Smart phones, laptops, tablet computers, and other devices are now standard devices that many people carry with them. In addition, many organizations and groups, such as sales teams, emergency responders, law enforcement, military, now equip their personnel with one or more mobile devices.

Applications, such as mapping, database access, communications, running on mobile devices have proven instrumental to these types of groups. However, these applications are dependent on broadband communications and/or large amounts of local storage on a mobile device. Thus, these applications can be severely limited by the mobile device range of connectivity, computing power, storage space, and especially, the battery power.

Unfortunately, mobile devices today generally suffer from several disadvantages, such as limited battery power and life, low-power processors, limited network availability and/or bandwidth, and finite data storage. Many computing use-cases are not well supported on mobile device, especially if the network has limited access to the Internet, dedicated servers, or other fixed infrastructure.

Some forms of resource management are known in the art such as load balancing network requests and power management. However, the known technology typically relies on using fixed infrastructure, such as geospatially fixed servers and access points.

Accordingly, it would be desirable to provide methods and systems that optimize the resources of a group of mobile devices.

### BRIEF DESCRIPTION OF THE DRAWINGS

Throughout the drawings, reference numbers may be re-used to indicate correspondence between referenced elements. The drawings are provided to illustrate example embodiments described herein and are not intended to limit the scope of the disclosure.

FIG. 1 shows an exemplary mobile computing cloud system in accordance with some embodiments of the present invention.

FIG. 2 shows an exemplary mobile device serving as node of the system shown in FIG. 1.

FIG. 3 shows an exemplary block diagram of the mobile device shown in FIG. 3.

FIG. 4 shows an exemplary process flow in accordance with the embodiments of the present invention.

### DESCRIPTION OF THE EMBODIMENTS

Various aspects of the disclosure will now be described with regard to certain examples and embodiments, which are intended to illustrate but not to limit the disclosure.

Overview

The embodiments provide a virtual mobile infrastructure (VMI) to effectively form a mobile computing cloud. The VMI is formed based on network manager applications running on one or more of the mobile device nodes in a system. The network manager applications of the VMI then operate in conjunction with each other to balance the memory, processing power, storage network connections, and in one embodiment, the battery life of the devices in the VMI. By balancing these aspects of the VMI, the mobile computing cloud can provide greater capacity and fault tolerance. For example, with a mobile computing cloud, large and detailed maps could be accessed when there is no cellular tower nearby.

Embodiments of the present invention improve upon basic network resource management by taking into account various factors of computing devices on the network including, but not limited to processor utilization, processor count, storage utilization, remaining battery power, and communications strength. More importantly, the system shall take into account the special needs inherent to mobile networks, such as battery power and limited memory.

In some embodiments, the system utilizes software, which communicates system resource states and offered services to other nodes on the network and receives system resources states and offered services from other notes on the network. In addition, the software stores this information to assist algorithms, which rank the services offered according to the system resource states and services offered. Nodes utilizing the network manager application are then able to locate and use the best node for particular service offerings.

Mobile computing clouds powered by a VMI of the embodiments offer larger storage capacity, larger computing power, and maximized group resources, such as maximized battery power and network connectivity, and fault tolerance. In addition, the VMI can choose optimal communication channels based on optimized data flows as it relates to devices current data plans. The mobile computing clouds may also provide the ability to accommodate a wide variety of types of devices with different capabilities to enhance the functionality of the mobile computing cloud as a whole.

Mobile computing clouds may be useful in a various applications, such as disaster relief, military applications and transport, security services, gaming, etc. For example, mobile aid workers may employ a mobile computing cloud to assist in communications and provide mapping information to assist the aid teams in their missions.

In addition, the VMI infrastructure may enable sharing communication channels between different vendors. This allows all devices to leverage available communication devices, whether they are commercially or government provided.

Reference will now be made to the accompanying drawings, which are incorporated in and constitute a part of this specification, illustrate several embodiments of the disclosure and together with the description, serve to explain the principles of the disclosure.

An Exemplary Mobile Computing Cloud

FIG. 1 shows an exemplary mobile computing cloud system 100 in accordance with some embodiments of the present invention. As shown, the system 100 may comprise node 102A-G that communicate over a network 104. These components and some relevant concepts will now be further described.

The nodes 102A-G may refer to any device that participates in the mobile computing cloud systems. For example, as shown, the nodes 102A-G may be various known devices, such as smart phones, tablet computers, laptop computers, etc. Any type of mobile device having some form of communications capability may serve as a node in the mobile computing cloud system of the embodiments.

Network 104 may refer to any communications infrastructure on a local or wide area scope on which the system described may communicate and operate. For example, network 104 may comprise a local area network, a metropolitan area network, the Internet, a private network, etc. The network 104 may utilize various forms of communications, such as wireline communications (e.g., Ethernet, fiber, cable, etc.) and/or wireless communications (e.g., WiFi, Bluetooth, cellular, etc.).

In general, the mobile computing cloud system creates a database on each node wherein the nodes may communicate their resource capability and resource state. A resource state may refer to the state of a resource of a particular node in the system 100 and may be noted in various forms. In some embodiments, the resource state may take the form of a number, a percentage value, an integer value, etc. For example, the resource state may represent parameters, such as processor utilization, number of bytes of storage, etc. present in the nodes 102A-G.

Individually or collectively the nodes 102A-G may offer various applications that provide services over the mobile computing cloud system 100. A service offered by the system 100 may refer to any network service offered by a node. For example, a mapping service may be service, such as a tiled mapping server available to other nodes. Other types of services may include, but are not limited to, database applications, communications, such as messaging, video/audio streaming, etc.

In order to manage the various services, the system 100 may provide a name resolution service that resolves a service's configured location, such as a Uniform Resource Locator (URL) with the currently preferred node offering this service.

During operation, the nodes 102A-G may multicast or broadcast various VMI messages to each other. A message may refer to one or more packets of information from a node to other nodes on the network 104. In one embodiment, the nodes 102A-G communicate their respective resource states to other nodes on the network by sending and receiving internet protocol messages. Nodes 102A-G may also announce a service they are making available to other nodes on the network 104.

When a node receives a message from another node, it stores one or more resource states and any announced services to a database (not shown in FIG. 1). For each service a node is aware of on the network 104, the nodes 102A-G rank the other nodes offering the service according to the resource states received from these nodes. In addition, resolution of the service is stored to the database including changes, if any, to a service (such as when a node is lost or powered down). This may include when the change took place, the former IP address for the URL, and a new address, such as an Internet Protocol (IP) address.

FIG. 2 shows an exemplary mobile device 102 serving as node of the system shown in FIG. 1. The nodes 102A-G may be generally any type of device that is mobile, battery powered, wearable, etc., having some form of network communications capability. As shown, for example, nodes 102A-G may comprise a processor 200, a memory 202, a storage 204, and a network input/output (I/O) 208 for communications with network 104. In addition, the nodes 102A-G may optionally comprise a user I/O 208 such as a keyboard, touchscreen, etc., and a display 210. These components are well known to those skilled in the art. Of course, one or more of nodes 102A-G may comprise other components and equipment. Those skilled in the art will recognize that any type of mobile computing device may be used in the embodiments.

Exemplary Network Manager running on a Node

FIG. 3 shows an exemplary block diagram of the mobile device shown in FIG. 3. In particular, one or more nodes 102A-G may execute a network manager application. As noted above, the network manager applications running on the nodes 102A-G collectively work together and form the VMI and operate as the mobile computing cloud system 100. In some embodiments, the network manager is software, e.g., that is written in Java, or C++, having a number of software components or classes that work in conjunction with each other. Various device drivers may also be installed on the various nodes to assist the network manager to collect the information and/or metrics used by the embodiments. For example, a device driver may be installed so that the network manager can access the battery state, network connectivity, network strength, etc. of a particular node.

In one embodiment, the network manager application may comprise a main program thread 300, a message receiver 302, a message sender 304, a decision engine 306, a resolution engine 308, and a database 310 stored within storage 204. The network manager uses the concept of a node state. A node state describes the system's resource capabilities. For example, as described further below, a node state may include: a node ID (e.g., IP address or MAC address); a timestamp; number of CPUs; CPU usage; storage capacity, storage utilization; remaining battery power; cellular strength; WiFi strength; Bluetooth strength; services and associated storing, receiving, and processing weights; and primary network type (cellular, WiFi, Bluetooth, etc.). These components will now be briefly described.

The main program 300 represents the main loop of the program. It is responsible for parsing a configuration file and spawning threads for the embodiments. When main program execution is started, the main program first loads and parses a configuration file (not shown) that contains various parameters used during the operation of the mobile computing cloud. The main program 300 then creates and initializes the database 310 in storage 204. Once the database 304 is initialized, main program 300 starts the message sender 304, the message receiver 302, and the decision engine 306.

Main program 300 may then enter an idle thread management state until a kill signal, i.e., a signal to shut down the system is sent by a user or administrator, after which it shuts down the message receiver 302, shuts down the message sender 304, and shuts down the decision engine 306. In one embodiment, the main program runs as a service level daemon on the nodes 102A-G.

Message receiver 302 represents a thread, which waits for messages from other nodes 102A-G on the network. When a message is received, the message receiver 302 parses the information and stores it to the database 310. In general, the message receiver 302 parses a message to determine the originating node, e.g., for example based on a unique identifier or address, and the corresponding current resource states and services of the nodes 102A-G.

In addition, message receiver 302 checks the database 310 to determine if the node has a corresponding record. If it does not have a corresponding record, a new record is created by the message receiver 302 or the main program 300. If it does not have a corresponding record, that record's last updated timestamp field is set to the current time, for example, as defined by the host operating system running on the node 102.

The message receiver 302 also checks to see if there are service records in the database 310, which have a node identifier (ID) field of the messages node's address, such as an IP address identifier. If the record does not exist, the message receiver 302 (or main program 300) creates a new record in the database 310. Otherwise, the existing record is updated with the current time.

In some embodiments, the message receiver 302 is also responsible for other database tasks. This may include deleting nodes, which have stopped communicating for a configurable amount of time and deleting states with timestamps older than a configurable amount of time.

The message sender 304 represents the thread that is responsible for obtaining resource states of its respective node, services and sending messages to other nodes 102A-G on the network 104 containing the resource states and services. The message sender 304 may send these messages in various intervals or on an event driven basis. The periodicity or timing of these messages may be determined based on parameters specified in the configuration file. In some embodiments, the message sender 304 sends its messages through the use of multicasting over network 104.

In some embodiments, the message sender 304 polls its node for node state values. Obtaining state information may be customized to be platform specific. Because of this, the network manager may utilize a various software components, such as a device driver, a Java library, or other types platform-specific libraries to poll system state values for which it is designed to provide. In one embodiment, services and weights are defined in the configuration file, as well as primary network type.

The message sender 304 is responsible for sending a node state packet about its own host to all other available nodes on the network. It undertakes this task at regular intervals defined in the configuration file.

The node state packet is represented in code by a payload class. This class contains the state information such as current CPU load and storage utilization, as well as a unique identifier (IP address and/or MAC address), available services, primary network type, and a current timestamp. Every sending interval, the payload class is instantiated with values obtained through the state manager with the host system's current state. It is then serialized to a byte array and multicasted across the network to other nodes.

The decision engine 306 represents the thread, which obtains information stored in the database 310 and determines the best node offering known services. In some embodiments, the decision engine 306 executes various algorithms to balance or optimize the resources of the nodes 102A-G that are available over the network 104 and form a VMI.

The decision engine 306 is also responsible for updating the name resolution engine 308. When the decision engine 306 is invoked, it queries the database 310 to determine the state of the VMI and the system 100. For example, the decision engine 306 may query the database 310 for weight values, which are used to rank resource states. In some embodiments, the decision engine 306 may then enter an idle state and waits for a configuration interval to be reached. In one embodiment, the nodes 102A-G are programmed to load, at startup, a configuration file, which specifies various parameters used by the decision engine including the configuration interval. Alternatively, the nodes 102A-G may download a configuration file after startup or during operation or be provided a configuration file, for example, by a server or manually by a user. In nodes 102A-G, the decision engine 306 may update the configuration interval upon receiving a new or updated configuration file.

Periodically, the decision engine 306 then performs its decision process to locate and determine the best of nodes 102A-G for various services. This process is further described with reference to FIG. 4.

Exemplary Process Flow

FIG. 4 shows an exemplary process flow in accordance with the embodiments of the present invention.

In stage 400, the message receiver 302 is invoked and receives various messages from the other nodes 102A-G. As noted, message receiver 302 parses a message to determine the originating node, e.g., for example based on a unique identifier or address, and the corresponding current resource states and services of the nodes 102A-G. In one embodiment, the message receiver 302 joins a configured multicast group IP and waits to receive a node state datagram packet from the other nodes 102A-G. In some embodiments, the messages shared between nodes 102A-G for the VMI are encrypted for security purposes.

In addition, message receiver 302 checks the database 310 to determine if the node has a corresponding record. If it does not have a corresponding record, a new record is created by the message receiver 302 or the main program 300. If it does not have a corresponding record, that record's last updated timestamp field is set to the current time, for example, as defined by the host operating system running on the node 102.

The message receiver 302 also checks to see if there are service records in the database 310, which have a node identifier (ID) field of the messages node's address, such as an IP address identifier. If the record does not exist, the message receiver 302 (or main program 300) creates a new record in the database 310. Otherwise, the existing record is updated with the current time.

Next, in stage 402, the decision engine 306 locates and ranks the nodes 102A-G. In particular, the decision engine 306 queries the database 310 for node resource states and services stored by the message receiver 302. The query results are then returned to the decision engine 306. The decision engine 306 may then refer to various tables in database 310 in order to locate and rank the nodes 102A-G. Various examples of such tables are illustrated in FIG. 4 and will now be described below

The nodes table 312 store static information about a node including its network IP address, the number of processor cores of the node, the storage capacity of the note, the primary network type of the node, and a last update field, which contains the timestamp of when the entry for this node was created or last updated.

The services table 314 stores information about the services advertised by other nodes. The node id field contains the node network IP address of the advertising service. The service ID field is a unique identifier for the table row. The service name field is the name of the service being advertised. The storing field is the storing data weight associated with the service. The retrieving field is the retrieving data weight associated with the service. The processing data field is the processing data weight associated with the service. The last update field is timestamp of when the entry for this node's service was created or last updated.

The state weight table 316 stores the storing data, retrieving data, and processing data weights for node stat values, excluding advertised services. In one embodiment, the state weights table 316 is created and populated at system startup from a configuration file, after which it is read-only. In other embodiments, the state weight table 316 may be dynamically updated

The states table 318 stores received node, excluding services. The state ID field is a unique identifier for the row. The node ID field identifies the network IP address of the node, which sent the state value. The state type field identifies the particular state value, such as CPU utilization. The time stamp field identifies when this state value was received.

The name updates table 320 stores the current and previously assigned IP address for each service.

The state types table 322 is a lookup table that defines the names of the states, such as CPU utilization, remaining battery, etc.

The node service scores table 324 stores the most recent scoring for each service/node ID combination.

The weight types table 326 stores the names of the different weight types used to assist with scoring.

In some embodiments, the database 310 may include a domains and records tables to store domain name service (DNS) records. In yet other embodiments, a quality score may be added to the node scores to account, for example, for network instability. In one embodiment, a stability score may be calculated to accompany a node's score to indicate how reliable the node is connected to the network or network manager.

The database 310 may also have an age or other type of score to indicate when a node 102 has been disconnected from the network 104 or powered down or otherwise unavailable. In some embodiments, network manager may then purge these node records from the database 310 based on this age score.

In stage 404, the decision engine 306 then ranks nodes for each known service according to one or more algorithms, which takes into account weights stored in the database, which are associated with resource states and services. In various embodiments, every node in a system is ranked for the services it can provide. However, in other embodiments, a subset of nodes may be ranked based on their resources or based on the metrics obtained from the tables in database 310. Below is one example of how the decision engine 306 determines the best nodes for each service.

In one embodiment, resource information used in the tables of database 310 are normalized to a score, for example, between 0 and 100 (e.g., to effectively indicate a percentage value expressing the state of the resource). For example, in one embodiment, the network managermay attempt to score and manage the resources of nodes 102A-G according to three parameters: storing data, retrieving data, and processing data. Relevant state values, such as CPU load have corresponding weight values for the three parameters, as do services offered by nodes 102. As noted above, these weights may be defined in a configuration file.

In one embodiment, the following formula may be used by the decision engine 306 to score a node:

For services 1 to n,

Score=Σσₙ(α(100−CPU)+β(100−Storage)+μ(Network)+γ(Battery)),

where

CPU is the node's CPU parameter;

Storage is the node's storage parameter;

Network is the node's network parameter;

Battery is the node's battery parameter;

σₙ is the service weight for each service, such as storing, retrieving, or processing, then n=3);

α is the CPU load weight;

β is the storage utilization weight;

μ is the network status weight; and

γ is the battery status weight.

In this embodiment, the formula may include any number of resource and resource weights. After scoring the nodes 102A-G, the system 100 may poll or query each of the nodes, e.g., starting with the nodes with the highest score, and if a response is received, the decision engine 306 may stop polling and write (e.g., host name and IP address) key value pairs to the name resolution engine 308, such as a DNS server or system hosts file.

In one example, a node 102A is receiving state packets from node 102D, node 102E, and node 102F via the network. Since they are laptops and may have relatively more resources, nodes 102D and node 102E may provide a map proxy service. This state and service information may be saved in the database 310 as shown below.

Meanwhile, the decision engine 306 may periodically look through the services saved to the database 310 and rank the nodes for each service. For example, for the map proxy service, the decision engine may find that node 102D and node 102E have this service.

Table 1 below illustrates this state.

| | | Storage | Network | |
|---|---|---|---|---|
| Node # | CPU Load | Utilization | Status | Battery |
| 102D | 23 | 25 | 80 | 50 |
| 102E | 40 | 75 | 60 | 25 |

Table 2 below illustrates exemplary weights that may be retrieved from the database. As seen in Table 2, each data activity category (storing, retrieving, and processing) and state combination has a weight associated with it. For example, CPU load is considered 50% less important for storing data than processing data.

| State | Storing Data | Retrieving Data | Processing Data |
|---|---|---|---|
| CPU Load | 0.5 | 0.8 | 1 |
| Storage Utilization | 1 | 0 | 0.75 |
| Network Status | 0.8 | 1 | 0.75 |
| Battery | 1 | 1 | 1 |

Table 3 illustrates some exemplary service weights that may be retrieved from the database. In particular, Table 3 shows the importance of each data activity category for the map proxy service. In this case, retrieving is the only data activity category considered important for the map proxy (its main function is to serve tiles). In some embodiments, this is a value set in the configuration file by the user of the node that advertises the service and can be changed. It is arguable that due to map proxy's caching features, storing, and processing data activities could be considered important as well and weighted higher than 0.

| Service | Service | Storing | Retrieving | Processing |
|---|---|---|---|---|
| ID | Name | Data | Data | Data |
| 2 | Mapproxy | 0 | 1 | 0 |

For example, based on the values in the tables above, the scores for node 102D and node 102E are as follows:

$$\begin{matrix}Node 102 D = 0 ( 0.5 ( 100 - 23 ) + 1 ( 100 - 25 ) + 0.8 ( 80 ) + 1 ( 50 ) + \\ 1 ( 0.8 ( 100 - 23 ) + 0 ( 100 - 25 ) + 1 ( 80 ) + 1 ( 50 ) + \\ 0 ( 1 ( 100 - 23 ) + 0.75 ( 00 - 25 ) + 0.75 ( 80 ) + 1 ( 50 ) \\ = 191.6\end{matrix}$$

$$\begin{matrix}Node 102 E = 0 ( 0.5 ( 100 - 40 ) + 1 ( 100 - 75 ) + 0.8 ( 60 ) + 1 ( 25 ) + \\ 1 ( 0.8 ( 100 - 40 ) + 0 ( 100 - 75 ) + 1 ( 60 ) + 1 ( 25 ) + \\ 0 ( 1 ( 100 - 40 ) + 0.75 ( 100 - 75 ) + 0.75 ( 60 ) + 1 ( 25 ) \\ = 133.0\end{matrix}$$

As shown above, the node 102D has a higher score, and thus, may be considered the better choice over node 102E for obtaining information from the map proxy service.

In the embodiments, the nodes 102 may be configured with various host names for applications based on the services that can be provided by the system 100. In some embodiments, the weights may be configured in a configuration file for each listed service. Then for each service, the name service is updated in the resolution engine 308 with the best node identified by the decision engine 306.

In stage 408, at various times, a node 102 may receive a service request. For example, a user of node 102C may request mapping information from node 102e. The resolution engine 308 is provided this request and searches database 310 for the highest node for the service ranked by the decision engine 306 (i.e., node 102D).

In stage 410, upon resolving the best node for the service request, the main program 300 may then invoke the message sender 304 to send a message to node 102D via network 104. Alternatively, the nodes 102A-G may provide an application programming interface to allow other software and applications to interface with the VMI and system 100 to access information stored in the database 310, e.g., for identifying best nodes for various services. In some embodiments, the message sender 304 may encrypt its messages for security purposes.

The features and attributes of the specific embodiments disclosed above may be combined in different ways to form additional embodiments, all of which fall within the scope of the present disclosure. Although the present disclosure provides certain embodiments and applications, other embodiments that are apparent to those of ordinary skill in the art, including embodiments, which do not provide all of the features and advantages set forth herein, are also within the scope of this disclosure. Accordingly, the scope of the present disclosure is intended to be defined only by reference to the appended claims.

What is claimed is:

1. A method of optimizing group resources of a group of mobile devices that are assembled to form a mobile computing cloud, said method comprising:
providing a virtual mobile infrastructure that collectively manages respective resources of the mobile devices; and
balancing, via the virtual mobile infrastructure, the resources of the mobile devices to achieve a desired group objective.

2. The method of claim 1, wherein balancing the resources comprises balancing memory resources of the mobile devices.

3. The method of claim 1, wherein balancing the resources comprises balancing processing power resources of the mobile devices.

4. The method of claim 1, wherein balancing the resources comprises balancing storage resources of the mobile devices.

5. The method of claim 1, wherein balancing the resources comprises balancing network connection resources of the mobile devices.

6. The method of claim 1, wherein balancing the resources comprises balancing battery power resources of the mobile devices.

7. A method of resource management in a collection of computing devices, said method:
communicating, by the collection of computing devices, respective states of system resources amongst each computing device;
determining the best available computing devices for one or more activities based upon the state of one or more system resources;
storing system resource information of other computing devices for the purpose of determining the best available computing devices.

8. The method of claim 7, further comprising determining the best available computing device based on its available battery power.

9. The method of claim 7, further comprising determining the best available computing device based on its available processors.

10. The method of claim 7, further comprising determining the best available computing device based on processor utilization.

11. The method of claim 7, further comprising determining the best available computing device based on its storage capacity.

12. The method of claim 7, further comprising determining the best available computing device based on its storage utilization.

13. The method of claim 7, further comprising determining the best available computing device based on its network utilization.

14. The method of claim 7, further comprising determining the best available computing device based on its network signal strength.

15. The method of claim 7, further comprising determining the best available computing device based on its available resources.
